(19) United States
(12) Patent Application Publication
(10) Pub. No.: US 2004/0227734 A1
(43) Pub. Date: Nov. 18, 2004

(54) PIXEL ARRAY

(76) Inventors: Yi-Chen Chang, Taipei (TW); Shuo-Hsiu Hu, Tainan (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/604,689

(22) Filed: Aug. 11, 2003

(30) Foreign Application Priority Data
May 13, 2003 (TW) 92112901

(51) Int. Cl. G09G 5/00

(52) U.S. Cl. 345/168

(57) ABSTRACT

A pixel array comprising a plurality of pixel structures is disclosed. Each pixel structure at least comprises a sub-pixel and a shadow pixel. The shadow pixel is positioned on one side of the sub-pixel. The shadow pixel is capable of producing electromagnetic radiation in the invisible portion of the electromagnetic spectrum. Through proper setting of shadow pixels, the pixel array can be divided into areas having different digital codes and a sensor can be used to pick up the electromagnetic radiation from the shadow pixels to find the location emitting the digital codes. Thus, the pixel array can be used in a non-touch panel input device.

### CROSS REFERENCE TO RELATED APPLICATIONS

This application claims the priority benefit of Taiwan application serial no. 92112901, filed May 13, 2003.

### BACKGROUND OF INVENTION

1. Field of the Invention

The present invention relates to a pixel array. More particularly, the present invention relates to a pixel array with a pixel structure having a shadow pixel to serve as an inputting device in a non-touch panel.

2. Description of the Related Art

As information technologies and wireless communicating techniques continue to advance, many convenient, lightweight and personalized communication products are out in the market. The conventional input method such as keying through a keyboard or selecting through a mouse is gradually replaced by pointing at a touch panel to save space.

FIG. 1 is a schematic cross-sectional view of a conventional touch panel. In FIG. 1, the touch panel 104 is attached to a display panel 102. Light from the display panel 102 emerges in the direction as indicated by the arrows after passing through the touch panel 104. Through a variation in the electric field due to piezoelectric, resistivity or capacitor effect when the touch panel 104 is touched using a finger or an object, the exact position of the touched location can be found.

However, the aforementioned screen touching method re- lates to the “contact-pressure” type of sensing and hence only has a limited resolution. Moreover, too much contact pressure applied to the touching screen during an input operation can easily damage the display panel.

Furthermore, because the touch screen is attached to the outermost layer of the display panel, light from an image has to penetrate through the touch panel. With the touch screen blocking off some of the outgoing light, brightness level of the display will be reduced. To increase the brightness level, more electric power has to be supplied to the display panel. Ultimately, there is a possible reduction of working life.

### SUMMARY OF INVENTION

Accordingly, one object of the present invention is to provide a pixel array with a plurality of pixel structures each having a shadow pixel to serve as an inputting device in a non-touch panel.

A second object of this invention is to provide a pixel array relying on sensing the electromagnetic radiation emitted from a shadow pixel to determine its actual location and hence increase the positional resolution of a display panel.

A third object of this invention is to provide a pixel array that does not require any touch screen over a display panel. Hence, the light emission efficiency of the display panel is brighter and possibility of damage to the display panel due to contact pressure is prevented.

To achieve these and other advantages and in accordance with the purpose of the invention, as embodied and broadly described herein, the invention provides a pixel array for a non-touch input panel. The pixel array comprises an array of pixel structures. Each pixel structure at least comprises a sub-pixel and a first shadow pixel. The first shadow pixel is positioned on one side of the sub-pixel. Furthermore, the first shadow pixel is fabricated using a material capable of producing electromagnetic radiation in the invisible portion of the spectrum.

In the aforementioned pixel structure, the first shadow pixel in the pixel array is set to emit one of two types of electromagnetic radiation. For example, the first shadow pixel is divided into an area with shadow pixel and another area with the shadow pixel removed (or not formed in the first place), wherein each of the shadow pixels has a different linear dimension (length), each of the shadow pixels has a different lateral dimension (width), each of the shadow pixels is fabricated using a different material, each of the shadow pixels emits electromagnetic radiation at a different wavelength and each of the shadow pixels has a different reflectivity so that a logic “0” and “1” signal can be produced.

In addition, a second shadow pixel may be introduced into each pixel structure. The second shadow pixel is positioned on the other side of the sub-pixel. The second shadow pixel is fabricated using a material capable of producing electromagnetic radiation in the invisible portion of the spectrum.

Similarly, the second shadow pixel in the pixel array is set to emit one of two types of electromagnetic radiation. For example, the second shadow pixel is divided into an area with shadow pixel and another area with the shadow pixel removed (or not formed in the first place), wherein each of the shadow pixels comprises a different linear dimension, each of the shadow pixels has a different lateral dimension, each of the shadow pixels is fabricated using a different material, each of the shadow pixels emits electromagnetic radiation at a different wavelength and each of the shadow pixels has a different reflectivity so that a logic “0” and “1” signal can be produced.

The pixel array of this invention comprises a plurality of pixel structures each having a shadow pixel suitably positioned for producing an electromagnetic radiation. Therefore, a sensor can be used to locate the shadow pixel emitting the electromagnetic radiation. Hence, the pixel array can be used to construct a non-touch display panel.

Because the display panel having the pixel structure of this invention utilizes the electromagnetic radiation from the shadow pixel to locate position, a resolution higher than the conventional touch screen method is obtained.

In addition, there is no need to mount a touch screen over the display panel when the pixel array of this invention is used to construct a non-touch display panel. Consequently, the display panel not only can have a brighter illumination, but can also avoid possible damage to the panel due to contact pressure.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a conventional touch panel.

FIG. 2 is a plane view of a pixel array according to one preferred embodiment of this invention.

FIG. 3 is a diagram showing the setting of the shadow pixel in each pixel structure to a different electromagnetic radiation state so that each pixel structure is able to display a different radiation emission signature according to a first preferred embodiment of this invention.

FIG. 4 is a diagram showing the setting of the shadow pixel in each pixel structure to a different electromagnetic radiation state so that each pixel structure is able to display a different radiation emission signature according to a second preferred embodiment of this invention.

FIG. 5 is a diagram showing the setting of the shadow pixel in each pixel structure to a different electromagnetic radiation state so that each pixel structure is able to display a different radiation emission signature according to a third preferred embodiment of this invention.

FIG. 6 is a diagram showing the setting of the shadow pixel in each pixel structure to a different electromagnetic radiation state so that each pixel structure is able to display a different radiation emission signature according to a fourth embodiment of this invention.

FIG. 7 is a diagram showing a group of sixteen pixel structures assembled to form a byte according to one preferred embodiment of this invention.

FIG. 8 is a diagram showing a sensor activated to carry out inputs through a display panel having the pixel array according to this invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

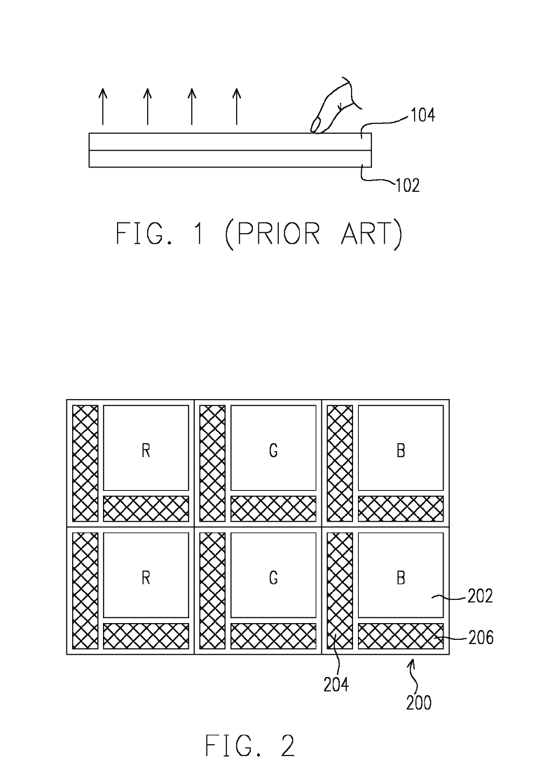

FIG. 2 is a plane view of a pixel array according to one preferred embodiment of this invention. In general, a display panel comprises a plurality of pixel structures organized into a regular array. To simplify the drawing, only a few pixel structures (6 in FIG. 2) are shown. Furthermore, the pixel array of this invention can be applied to both liquid crystal display panels and organic electroluminescent display panels.

As shown in FIG. 2, each pixel structure 200 in a pixel array at least comprises a sub-pixel 202 and a shadow pixel 204. Each sub-pixel 202 displays a color such as red (R), green (G) or blue (B), for example. The plurality of sub-pixels 202 are set to form a specific pattern including, for example, a mosaic pattern, a triangular pattern, a strip pattern or a four-pixel (RGGB) pattern (not shown).

The shadow pixel 204 (or the X shadow pixel) in the shape of a longitudinal strip is located on one side of the sub-pixel 202 within the pixel structure 200. The shadow pixel 204 is set up in a non-transparent region of the pixel structure 200, for example. The shadow pixel 204 is fabricated using a self-activated or externally activated material capable of producing electromagnetic radiation primary in the invisible part of the electromagnetic spectrum. The invisible electromagnetic radiation refers, for example, to fluorescent light, infrared or ultraviolet light. Thus, through the incorporation of a shadow pixel 204 to each pixel structure 200, the pixel array is able to produce invisible electromagnetic radiation for determining its actual emission location relative to the panel.

Aside from the shadow pixel 204, an additional shadow pixel 206 (or the Y shadow pixel) may be incorporated into each pixel structure 200. The shadow pixel 206 is a longitudinal strip set up on the other side of the sub-pixel 202. Similarly, the shadow pixel 206 is set up in a non-transparent region of the pixel structure 200, for example. The shadow pixel 206 is fabricated using a self-activated or externally activated material capable of producing electromagnetic radiation primary in the invisible part of the electromagnetic spectrum. The invisible electromagnetic radiation refers, for example, to fluorescent light, infrared or ultraviolet light. With the addition of another shadow pixel 206, the capacity to detect and locate the electromagnetic emission relative to the display panel is further enhanced.

The shadow pixel 204 (or the shadow pixel 206) is individually set to one of two different types of electromagnetic radiation states. Hence, a detector set to pick up signals from the shadow pixels 204 is able to receive one of the two radiation states from the shadow pixel 204 (or the shadow pixel 206) and convert the radiation signal to a binary bit such as a logic “1” or “0”. Thereafter, through a combination of the binary signals, the pixel array is able to produce a unique digital code.

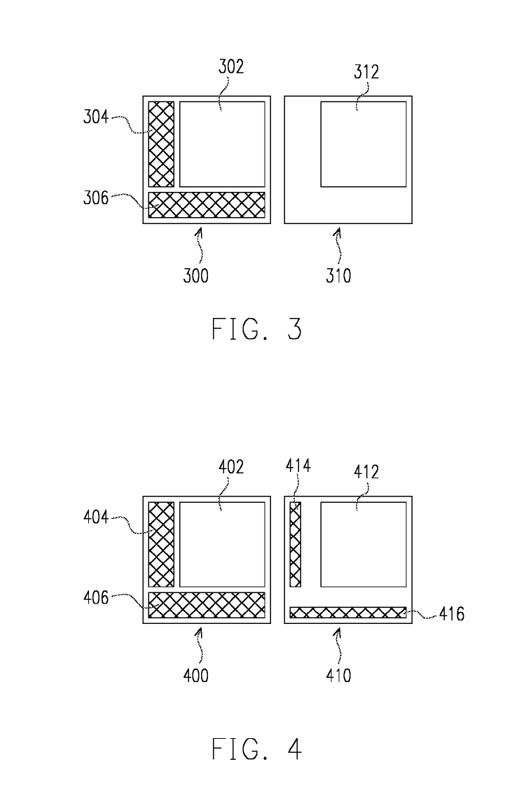

FIG. 3 is a diagram showing the setting of the shadow pixel in each pixel structure to a different electromagnetic radiation state so that each pixel structure is able to display a different radiation emission signature according to a first preferred embodiment of this invention. In FIG. 3, the shadow pixel 304 (the X shadow pixel) is used as an illustration for two neighboring pixel structures 300 and 310. A shadow pixel 304 is set in the pixel structure 300 but the pixel structure 310 has none. Since the pixel structure 300 and the pixel structure 310 are in different radiation states, a binary bit such as “0” or “1” can be produced for detection. Likewise, the shadow pixel 306 (the Y shadow pixel) can be similarly arranged.

FIG. 4 is a diagram showing the setting of the shadow pixel in each pixel structure to a different electromagnetic radiation state so that each pixel structure is able to display a different radiation emission signature according to a second preferred embodiment of this invention. In FIG. 4, the shadow pixels 404, 414 (the X shadow pixels) within two neighboring pixel structures 400 and 410 are used as an illustration. A wider shadow pixel 404 is set in the pixel structure 400 while a narrower shadow pixel 414 is set in the pixel structure 410 so that the pixel structures 400 and 410 have different electromagnetic radiation states (due to a difference in width). Likewise, the shadow pixels 406, 416 (the Y shadow pixels) can be similarly arranged.

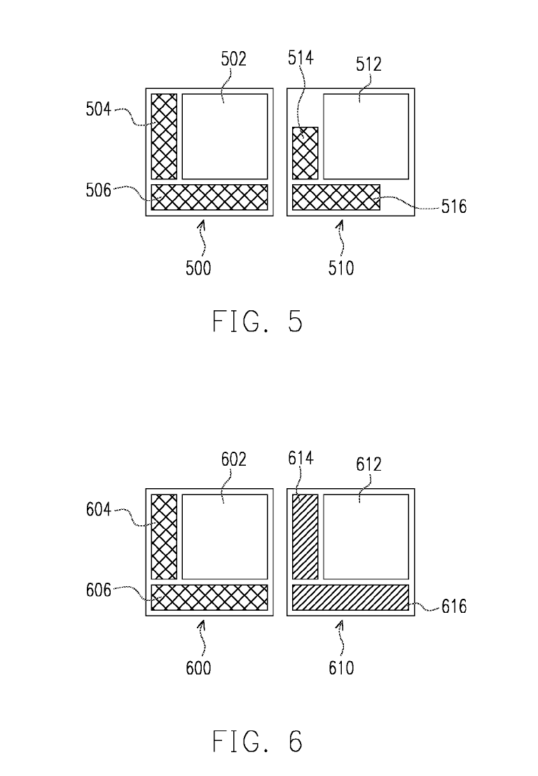

FIG. 5 is a diagram showing the setting of the shadow pixel in each pixel structure to a different electromagnetic radiation state so that each pixel structure is able to dis- play a different radiation emission signature according to a third preferred embodiment of this invention. In FIG. 5, the shadow pixels 504, 514 (the X shadow pixels) within two neighboring pixel structures 500 and 510 are used as an illustration. A longer shadow pixel 504 is set in the pixel structure 500 while a shorter shadow pixel 514 is set in the pixel structure 510 so that the pixel structures 500 and 510 have different electromagnetic radiation states (due to a difference in length). Likewise, the shadow pixels 506, 516 (the Y shadow pixels) can be similarly arranged.

FIG. 6 is a diagram showing the setting of the shadow pixel in each pixel structure to a different electromagnetic radiation state so that each pixel structure is able to display a different radiation emission signature according to a fourth preferred embodiment of this invention. In FIG. 6, the shadow pixels 604, 614 (the X shadow pixels) within two neighboring pixel structures 600 and 610 are used as an illustration. The shadow pixel 604 located in the pixel structure 600 is fabricated using a different material, a material having a different emission wavelength or a different reflectivity from the shadow pixel 614 located in the pixel structure 610 so that the pixel structures 600, 610 have different radiation states. Likewise, the shadow pixels 606, 616 (the Y shadow pixels) can be similarly arranged.

In FIGS. 3 through 6, the pixel structures are fabricated with different electromagnetic radiation states. However, a pixel array may contain pixel structures having identical or different electromagnetic radiation states.

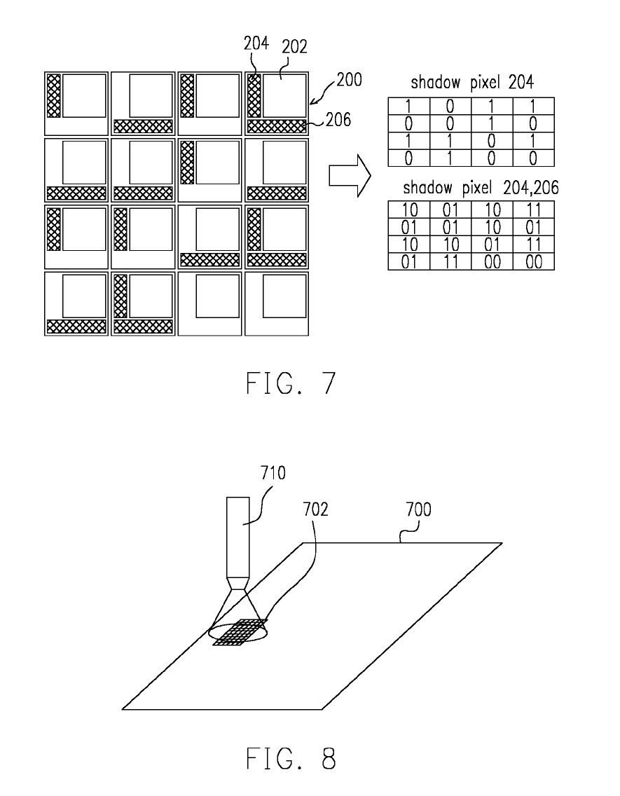

FIG. 7 is a diagram showing a group of sixteen pixel structures assembled to form a byte according to one preferred embodiment of this invention. As shown in FIG. 7, the pixel structures 200 within a byte can have different radiation states depending on the actual setup. In general, for the shadow pixels 204 (or the shadow pixel 206), the pixel structure with a shadow pixel is defined as “1” and one without a shadow pixel is defined as “0”. If all the shadow pixels 204 within this byte are scanned, a group of digital codes as shown in FIG. 7 is obtained. Furthermore, if all the shadow pixels 204 and 206 within this byte are scanned, another group of digital codes as shown in FIG. 7 is obtained. Hence, by dividing the pixel array into bytes each with a different value (digital codes) and associating each location (on the display panel) with a corresponding digital code, an exact location on the display panel can be obtained through the digital code.

In the pixel structure or pixel array of FIGS. 2 through 7, locations can be found with the X shadow pixels alone. In practice, the presence of Y shadow pixel in each pixel structures provides two additional advantages. When the Y shadow pixels are combined with the X shadow pixels, the number of distinguishable digital codes that can be produced from each location is increased. For example, with the X shadow pixels alone, a byte containing n pixel structures can locate 2n locations. However, if both the X and the Y shadow pixels are deployed, altogether 2*2n locations can be located. Another advantage is that a display panel having the pixel array of this invention is able to identify an exact location whether the panel is oriented vertically or horizontally.

FIG. 8 is a diagram showing a sensor activated to carry out inputs through a display panel having the pixel array according to this invention. As shown in FIG. 8, the pixel array within the display panel 700 comprises a plurality of pixel structures 702 (only a portion of the pixel structures is shown) each having a shadow pixel therein. To input data into the display panel 700, a sensor 710 posed over the display panel 700 receives the electromagnetic radiation emitted from the pixel structures 702 to find a digital code for the location. Thereafter, using an appropriate formula, the location of the sensor 710 relative to the location of the panel can be deduced from the digital code. In other words, data can be fed through the display panel without actually touching the surface of a touch panel.

In summary, major advantages of this invention includes:

1. The pixel array of this invention has a plurality of pixel structures each having a shadow pixel suitably positioned on the display panel to produce electromagnetic radiation so that a sensor can be used to locate the shadow pixel emitting the electromagnetic radiation. Hence, the pixel array can be used to construct a non-touch display panel.

2. Because the display panel having the pixel structure of this invention utilizes the electromagnetic radiation from the shadow pixel to locate position, a resolution higher than the conventional touch screen method is obtained.

3. Because the pixel array of this invention operates as a non-touch display panel, there is no need to mount a touch screen over the display panel. Consequently, the display panel not only can have a brighter illumination, but can also avoid possible damage to the panel due to contact pressure.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A pixel array for a non-touch panel input device, wherein the pixel array at least comprises a plurality of first pixel structures with each pixel structure at least comprising:
a sub-pixel; and
a first shadow pixel positioned on one side of the sub-pixel.

2. The pixel array of claim 1, wherein the first shadow pixel is fabricated using a material capable of producing electromagnetic radiation in the invisible portion of the light spectrum.

3. The pixel array of claim 1, wherein the first shadow pixel is set to emit electromagnetic radiation either in a first electromagnetic radiation state or in a second electromagnetic radiation state such that the first and the second electromagnetic radiation states are different from each other.

4. The pixel array of claim 3, wherein the first shadow pixel in the first electromagnetic radiation state has a length or width different from the first shadow pixel in the second electromagnetic radiation state.

5. The pixel array of claim 3, wherein the first shadow pixel in the first electromagnetic radiation state has a reflectivity different from the first shadow pixel in the second electromagnetic radiation state.

6. The pixel array of claim 3, wherein the first shadow pixel in the first electromagnetic radiation state radiates with a wavelength different from the first shadow pixel in the second electromagnetic radiation state.

7. The pixel array of claim 3, wherein the first shadow pixel in the first electromagnetic radiation state is fabricated using a material different from the first shadow pixel in the second electromagnetic radiation state.

8. The pixel array of claim 1, wherein each first pixel structure furthermore comprises a second shadow pixel positioned on the other side of the sub-pixel.

9. The pixel array of claim 8, wherein the second shadow pixel is fabricated using a material capable of producing electromagnetic radiation in the invisible portion of the spectrum.

10. The pixel array of claim 8, wherein the second shadow pixel is set to emit electromagnetic radiation either in a third electromagnetic radiation state or in a fourth electromagnetic radiation state such that the third and the fourth electromagnetic radiation state are different from each other.

11. The pixel array of claim 10, wherein the second shadow pixel in the third electromagnetic radiation state has a length or width different from the second shadow pixel in the fourth electromagnetic radiation state.

12. The pixel array of claim 10, wherein the second shadow pixel in the third electromagnetic radiation state has a reflectivity different from the second shadow pixel in the fourth electromagnetic radiation state.

13. The pixel array of claim 10, wherein the second shadow pixel in the third electromagnetic radiation state radiates with a wavelength different from the second shadow pixel in the fourth electromagnetic radiation state.

14. The pixel array of claim 10, wherein the second shadow pixel in the third electromagnetic radiation state is fabricated using a material different from the second shadow pixel in the fourth electromagnetic radiation state.

15. The pixel array of claim 1, wherein the pixel array furthermore comprises a plurality of second pixel structures with each second pixel structure at least having a sub-pixel without a first shadow pixel such that the sub-pixel in each second pixel structure is located in a position corresponding to the sub-pixel of the first pixel structure.

16. The pixel array of claim 15, wherein each second pixel structure furthermore comprises a second shadow pixel positioned on the other side of the sub-pixel corresponding to the second shadow pixel in the first pixel structure.

17. The pixel array of claim 16, wherein the second shadow pixel is fabricated using a material capable of producing electromagnetic radiation in the invisible part of the spectrum.
